(19) United States
(12) Patent Application Publication
(10) Pub. No.: US 2010/0088307 A1
(43) Pub. Date: Apr. 8, 2010

(54) SEARCH CONDITION DESIGNATION APPARATUS, SEARCH CONDITION DESIGNATION METHOD, AND PROGRAM

(75) Inventor: Shinichiro Watanabe, Kawasaki-shi (JP)

Correspondence Address: CANON U.S.A. INC. INTELLECTUAL PROPERTY DIVISION, 15975 ALTON PARKWAY, IRVINE, CA, 92618-3731, US

(73) Assignee: CANON KABUSHIKI KAISHA, Tokyo (JP)

(21) Appl. No.: 12/571,583

(22) Filed: Oct. 1, 2009

(30) Foreign Application Priority Data
Oct. 2, 2008 (JP) 2008-257277

(51) Int. Cl. G06F 17/30

(52) U.S. Cl. 707/706; 707/E17.014

(57) ABSTRACT

A search condition designation apparatus includes an attribute value presentation unit configured to present a list of an attribute value selectable for each attribute, an attribute value designation accepting unit configured to accept designation of the attribute value from the list of the attribute value presented by the attribute value presentation unit, an attribute presentation unit configured to present a list of an attribute corresponding to the attribute value the designation of which is accepted by the attribute value designation accepting unit, an attribute designation unit configured to accept designation of the attribute from the list of the attribute presented by the attribute presentation unit, and a search execution unit configured to execute search of data using a search condition based on the attribute value the designation of which is accepted by the attribute value designation accepting unit and the attribute the designation of which is accepted by the attribute designation unit.

### BACKGROUND OF THE INVENTION

1. Field of the Invention

The present invention relates to a technique for designating a search condition used for searching data.

2. Description of the Related Art

Conventionally, there is known a technique for searching a search target such as a document, an image, or a video image by using a search system. In searching a search target, some search systems require a user to directly input an attribute value such as “John Doe”, “JPEG”, or “September, 2007” displayed as an option for a search attribute that is prepared in advance, for example, “author”, “type”, or “last save date”.

According to another search system, a user can narrow down search targets by selecting a condition from a pull-down menu. Further, there is also a system that dynamically generates a search option using a keyword input by the user, such as the frequently asked question (FAQ), and displays the generated option.

Japanese Patent Application Laid-Open No. 2003-248689 discusses a method for dynamically generating options by using search target data that is hierarchically clustered. According to this method, an element of a child cluster is presented as an option according to a comparison result between an input search keyword and a hierarchical cluster element.

According to the conventional search system, metadata that is automatically assigned by the system is mainly information about a “person” such as a user ID, or a “date” such as a creation date, a last saved date, and a print date. Thus, for example, even if a number of selectable attributes such as an “author”, a “last person to save document”, and a “last person to print document” are provided, in most cases the same “person” is selected as the attribute value.

However, depending on the state, the user may sometimes want to select “John Doe” as the “author”, the “last person to save document”, and the “last person to print document”, or may want to designate “John Doe” only as the “author” and “Jane Doe” as the “last person to save document” and the “last person to print document”. Thus, it is not possible to simply and automatically apply the same attribute value to all the attributes of the “person”, and it is a burden for the user to select each attribute one by one in entering the conditions for the search.

Further, if the user could not obtain a desired result and perform the search again, the user needs to change a part of the selected attribute. However, since the user cannot determine whether the attribute value to be changed will effect increases or decreases of a result of the refined search that the user expects in advance, determining the condition again has not been easy for the user.

The present invention is directed to reducing time and effort of a user required for designating a search condition and facilitating search of a desired search target. Further, the present invention is directed to enabling a user to figure out increase or decrease of a number of a search results when the search condition is changed before the actual search is performed.

### SUMMARY OF THE INVENTION

According to an aspect of the present invention, a search condition designation apparatus includes an attribute value presentation unit configured to present a list of an attribute value which is selectable for each attribute, an attribute value designation accepting unit configured to accept designation of the attribute value from the list of the attribute value which is presented by the attribute value presentation unit, an attribute presentation unit configured to present a list of an attribute corresponding to the attribute value the designation of which is accepted by the attribute value designation accepting unit, an attribute designation unit configured to accept designation of the attribute from the list of the attribute which is presented by the attribute presentation unit, and a search execution unit configured to execute search of data using a search condition based on the attribute value the designation of which is accepted by the attribute value designation accepting unit and the attribute the designation of which is accepted by the attribute designation unit.

According to another aspect of the present invention, a method for designating a search condition by a search condition designation apparatus includes presenting a list of an attribute value selectable for each attribute, accepting designation of the attribute value from the presented list of the attribute value, presenting a list of the attribute corresponding to the attribute value the designation of which is accepted, accepting designation of the attribute from the presented list of the attribute, and executing search of data using a search condition based on the attribute value the designation of which is accepted and the attribute the designation of which is accepted.

According to yet another aspect of the present invention, a computer-readable storage medium storing a program for causing a computer to perform operations includes presenting a list of an attribute value selectable for each attribute, accepting designation of the attribute value from the presented list of the attribute value, presenting a list of attribute corresponding to the attribute value the designation of which is accepted, accepting designation of the attribute from the presented list of the attribute, and executing search of data using a search condition based on the attribute value the designation of which is accepted and the attribute the designation of which is accepted.

According to the present invention, once an attribute value is designated as a search condition, a list of attributes corresponding to the attribute value is presented, and an attribute to which the designated attribute value is to be applied is further designated as an additional search condition from the presented attribute list. Thus, according to the present invention, time and effort of a user for designating the search condition can be reduced and a desired search target can be obtained more easily.

Further, according to the present invention, since a difference between a number of additional search results where the attribute value that is designated as the search condition is applied to each attribute and a number of search results of a current search is presented, increase or decrease of the number of the search results when the search condition is changed can be obtained before an actual search is executed.

Further features and aspects of the present invention will become apparent from the following detailed description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 is a block diagram illustrating an overall configuration of a search condition designation apparatus according to an exemplary embodiment of the present invention.

FIG. 2 illustrates configurations of a document metadata management table stored in a storage device.

FIG. 3 illustrates a configuration of an attribute value presentation set table stored in a random access memory (RAM).

FIG. 4 illustrates a configuration of an attribute presentation set table stored in the RAM.

FIG. 5 illustrates an example of a screen configuration of a search screen displayed on an output device.

FIG. 6 illustrates an example of a configuration of a reselection screen for refining search condition which is displayed when a user presses a “RESELECT” button in the search screen in FIG. 5 to change the refined search condition which has been selected when attribute values to be references are selected in a selection area by the user.

FIG. 7 illustrates an example of a screen which displays a new search result when the refined search condition in the reselecting screen in FIG. 6 is reselected and “JOHN DOE” is added as an attribute value to the “LAST PERSON TO PRINT DOCUMENT”.

FIG. 8 is a flowchart illustrating a basic operation of the search condition designation apparatus according to an exemplary embodiment of the present invention.

FIG. 9 is a flowchart illustrating an operation of attribute value presentation processing as an example of step S804 in FIG. 8.

FIG. 10 is a flowchart illustrating an operation of attribute presentation processing as an example of step S804 in FIG. 8.

FIG. 11 is a flowchart illustrating an operation of cursor movement processing as an example of step S804 in FIG. 8.

FIG. 12 is a flowchart illustrating an operation of search execution processing as an example of step S804 in FIG. 8.

FIG. 13 is a flowchart illustrating an operation of document registration processing as an example of step S804 in FIG. 8.

FIG. 14 is an example of a screen configuration where only an attribute having “John Doe” as the attribute value is displayed as an option.

### DESCRIPTION OF THE EMBODIMENTS

Various exemplary embodiments, features, and aspects of the invention will be described in detail below with reference to the drawings.

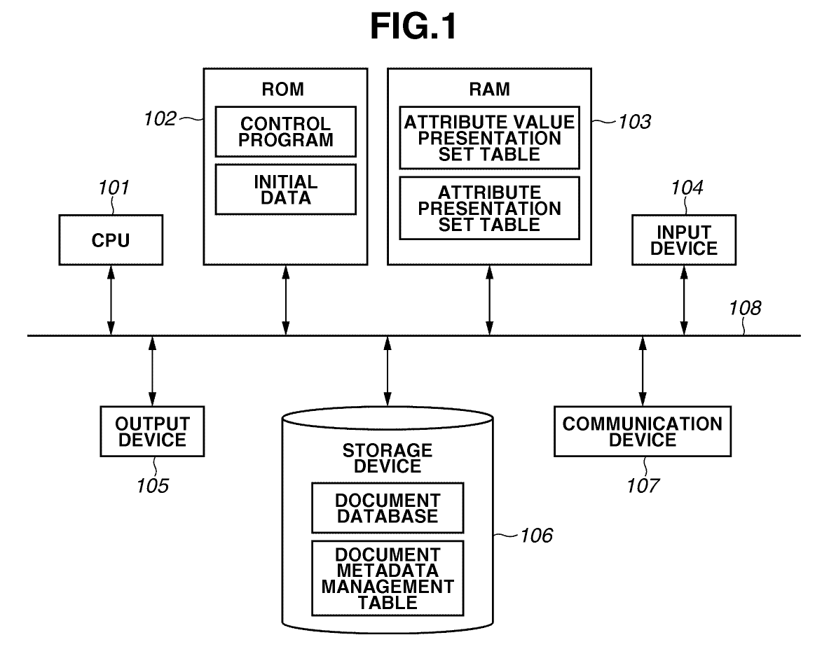

FIG. 1 is a block diagram illustrating an overall configuration of a search condition designation apparatus according to an exemplary embodiment of the present invention. In FIG. 1, a central processing unit (CPU) 101 executes calculation and logical decision necessary for displaying an image and controls each component connected via a bus 108.

A read-only memory (ROM) 102 stores a control program including processing procedures of the CPU 101 and various types of initial data. A RAM 103 is used as a work area for temporary storing data while the CPU 101 executes the control program. An attribute value candidate table and an attribute candidate table, which are described below, are temporarily stored in the RAM 103.

An input device 104 includes a keyboard and a mouse. An output device 105 includes a liquid crystal display or the like. The liquid crystal display of the output device 105 can include a touch panel having an input function. A storage device 106 includes various disk devices such as a hard disk, a flash memory, and the like and stores a document database and a document metadata management table.

A communication device 107 is an external input/output device such as a universal serial bus (USB) device or a wired or a wireless communication device such as a modem, and exchanges data with an external device. The bus 108 is used when the above-described CPU 101 and the devices 102 to 107 exchange the control program and data.

The search condition designation apparatus according to the present embodiment includes a function of searching and acquiring data in the storage device 106 or in an external storage device that is communicatable via the communication device 107 based on a search request entered by a user by using the input device 104. The acquired data is sent to an external personal computer (PC) or output to an external output apparatus such as a facsimile machine or a printer via the communication device 107.

The above-described functions are realized by the CPU 101 processing the control program in the ROM 102, or a control program which is transferred from an external device to the RAM 103 via the bus 108.

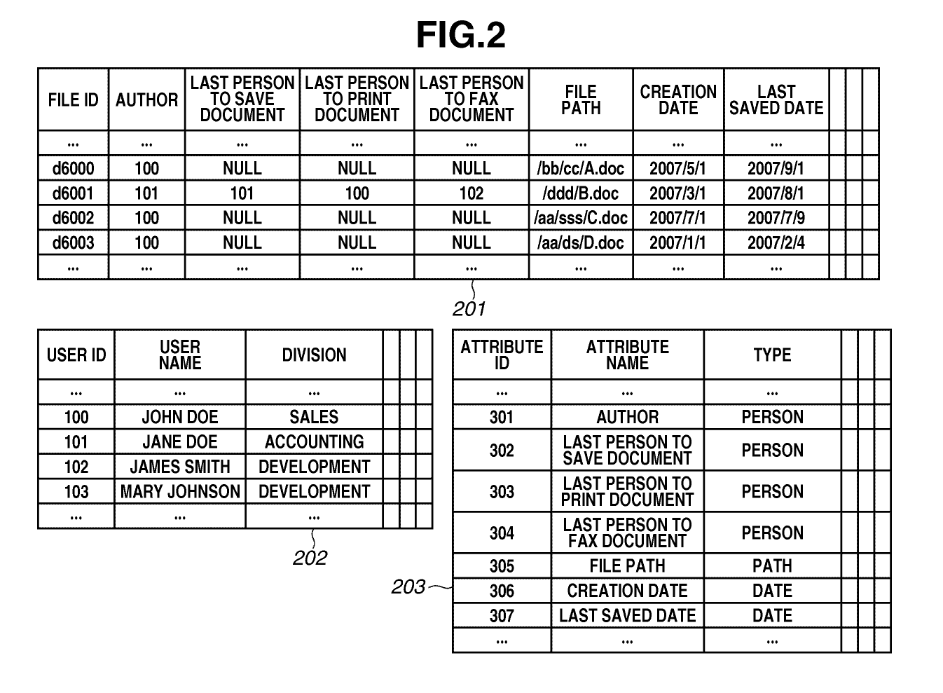

FIG. 2 illustrates configurations of a document metadata management table stored in the storage device 106. The document metadata management table includes a document data table 201, a user table 202, and an attribute management table 203, which are described below.

The document data table 201 is used for managing document data stored in the document database. In the document data table 201, various types of metadata are managed in association with each file ID of the document data stored in the document database. The metadata is, for example, an author of the document data, the last person to save the document data, the last person to print the document data, the last person to send the document data by FAX, file path information indicating a location where the document data is stored, creation date of the document data, and the last saved date of the document data.

While records of actions by the user such as creating, saving, and printing the document data, and transmitting the document data by FAX are managed according to the document data table 201, other actions such as copying and mail transmission can also be managed according to the functions which the user can use.

The user table 202 is used for managing the user registered in the search condition designation apparatus. The user table 202 includes a name and a division of the user which are associated with each other and managed for each user ID. Further, the user table 202 is associated with the document data table 201 by the user ID.

The attribute management table 203 is used for managing the attributes that are automatically assigned by the search condition designation apparatus. The attribute management table 203 includes an attribute name and an attribute type which are associated with each other and managed for each attribute ID.

The document data table 201 and the user table 202 include data of all documents and users registered in the search condition designation apparatus.

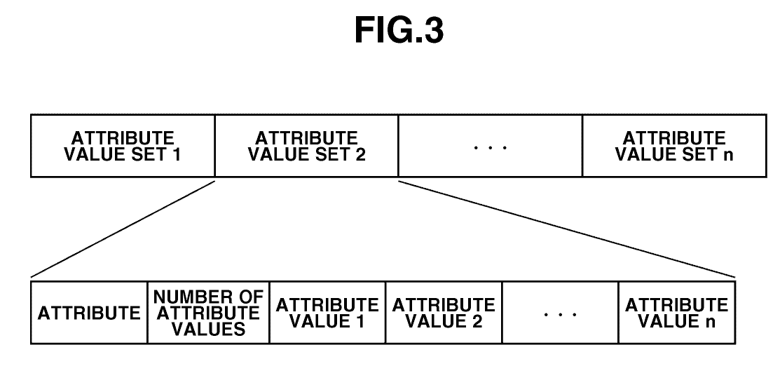

FIG. 3 illustrates a configuration of the attribute value presentation set table stored in the RAM 103. The attribute value presentation set table is generated and stored during a process for presenting the attribute value. Further, the attribute value presentation set table includes a list of a plurality of attribute value sets. Each of the attribute value sets has a list including an attribute, a number of the attribute values included in the attribute, and the attribute value.

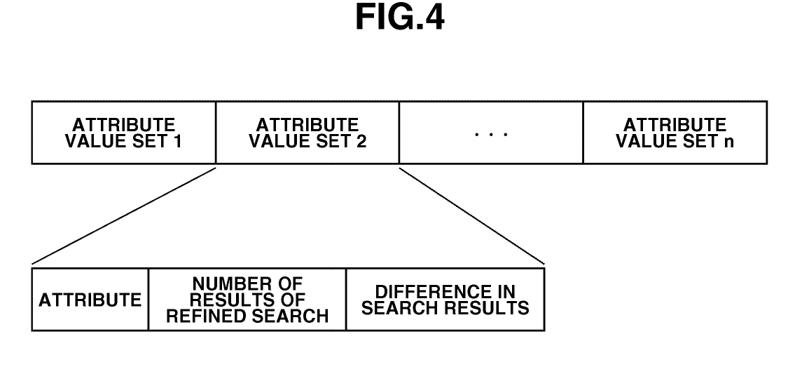

FIG. 4 illustrates a configuration of the attribute presentation set table stored in the RAM 103. The attribute presentation set table stores information about the attribute to which the attribute value can be applied, and is generated and stored during a process for presenting the attribute. Further, the attribute presentation set includes a list of a plurality of pieces of attribute information. Each pieces of the attribute information includes the attribute, a number of new document sets (search results) when the search is performed again by adding “attribute=attribute value” to a refined search condition, and difference in a number of the document sets (search results) between that of the refined search and that of the current search.

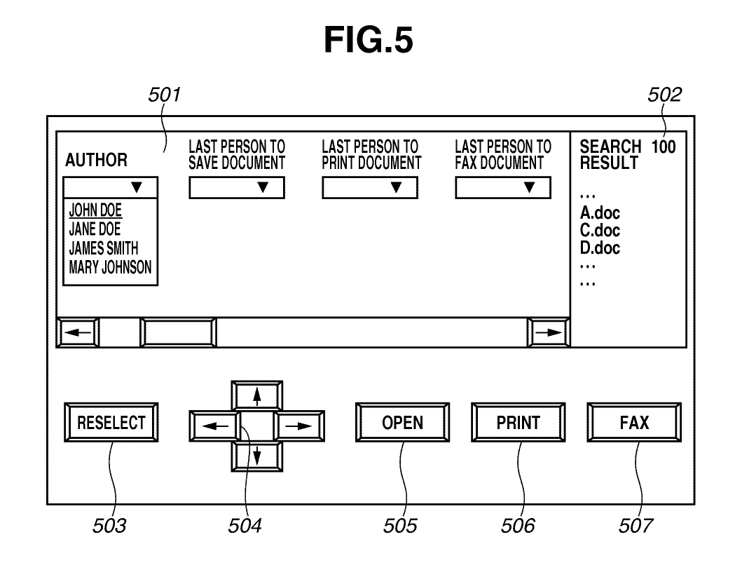

FIG. 5 is a configuration example of a search screen displayed on the output device 105. The search screen includes a selection area 501 and a result display area 502. The user selects the attribute value in the document data table 201 as a condition for the refined search of the document data using a pull-down list in the selection area 501. The result of the search is displayed in the result display area 502.

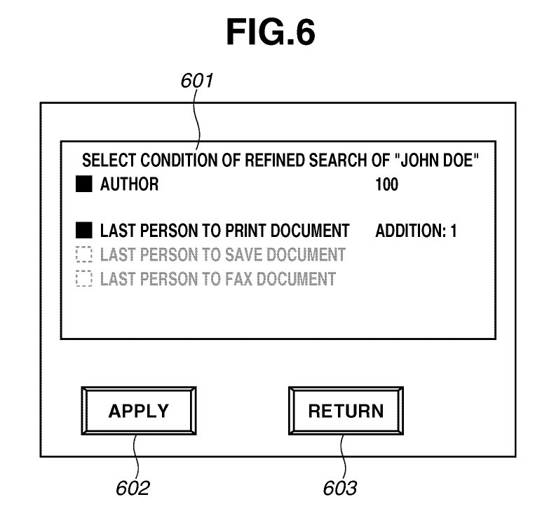

A reselect button 503 is used for displaying a screen illustrated in FIG. 6. The screen in FIG. 6 is used for changing the condition for the refined search selected from the selection area 501. A move button 504 is used for selecting an item on the screen. If the user operates an open button 505, contents of the document data that is selected in the result display area 502 is displayed by a viewer or an editor.

If the user operates a print button 506, the document data that is selected in the result display area 502 is output from the printer. If the user operates a FAX button 507, the document data that is selected in the result display area 502 is transmitted by the facsimile machine.

If the user selects “author” in the selection area 501, a pull-down list is displayed and, for example, author names acquired by the following structured query language (SQL) sentence are displayed.

“SELECT author FROM document data table GROUP BY author”. FIG. 5 illustrates the screen where “John Doe” is selected by the user.

On the other hand, a list of document data according to the refined search using the author name which is selected from the pull-down list of the above-described “author” field is displayed in the result display area 502. For example, a result to be displayed if “John Doe” is selected as the attribute value of the “author” attribute is obtained using the following SQL sentence.

“SELECT file ID FROM document data table WHERE author=‘John Doe’”

FIG. 6 is an example of the screen for reselecting the refined search condition that is used to change the search condition which is selected from the search screen illustrated in FIG. 5. The screen in FIG. 6 is displayed when the user selects the attribute value that is to be a reference value of the search from the selection area 501, and then presses the reselect button 503.

The user can apply the selected attribute value to other attributes by using the reselection screen. Information about an attribute group to which the attribute value can be applied is stored in the storage device 106. According to the present exemplary embodiment, attributes are classified into the attribute groups according to the attribute types, for example, the date or the name of the person.

In FIG. 6, an attribute to which the selected attribute value can be applied and the difference in the number of search results obtained between the current search and the refined search are simultaneously displayed in an attribute selection area 601. The user can control increase/decrease of the number of search results using this information.

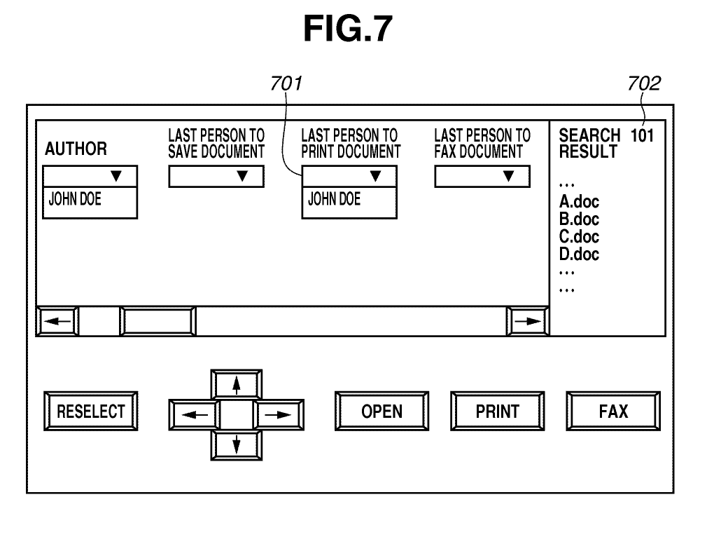

The user uses an apply button 602 for applying the condition for the refined search that the user selected from the attribute selection area 601. If the user presses the apply button 602, the screen changes to the search screen illustrated in FIG. 5, and a screen illustrated in FIG. 7 is displayed as a result of the search. If the user presses a return button 603, the reselection is cancelled and the search screen illustrated in FIG. 5 is displayed again.

It is assumed that, for example, the user searches for a document “B.doc” created by “John Doe” but the document “B.doc” has actually been a document printed by “John Doe”, so that the document is not hit as the search target.

In such a case, the user displays the reselection screen illustrated in FIG. 6 to search for the document again.

Even if “John Doe” is selected, if data which includes an attribute that has “John Doe” as its attribute value does not exist, the selection does not affect the result of the search. Thus, such an attribute is not displayed, or is distinctively displayed in an unselectable state (i.e., gray-out) in the attribute selection area 601.

If the data which includes the attribute that has “John Doe” as its attribute value exists, then the attribute is displayed on the screen as illustrated in FIG. 6 as the refined search conditions which can be changed. In FIG. 6, the attributes that apply to the attribute value “John Doe” are listed. The attributes are “last person to print document”, “last person to save document” and “last person to send FAX”.

However, the data which includes the attribute of the “last person to print document” has “John Doe” as its attribute value. Thus, the “last person to print document” is displayed in a selectable state, and other attributes gray out and displayed in the unselectable state in FIG. 6. Additionally, the screen in FIG. 6 illustrates a state where the “last person to print document” is additionally selected. Accepting the additional designation of the “last person to print document” is an example of processing by an attribute designation accepting unit according to the present invention.

According to the present exemplary embodiment, an “OR” operation is applied to combine each of the selected attributes. However, a button for an “AND” operation or a button for excluding the attribute that is already selected (“author” in this case) from the refined search condition can be provided as another embodiment so as to realize flexible arrangement of the refined search condition.

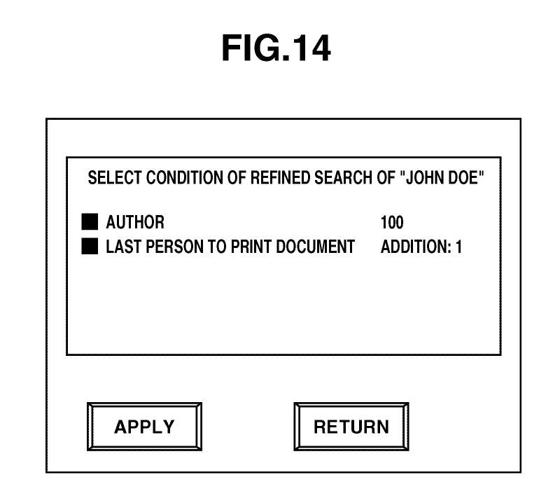

Although attributes of the same attribute type (“person”) are displayed in FIG. 6 as options, attributes that do not have “John Doe” as their attribute value are displayed in gray-out and thus cannot be selected. As another embodiment, as illustrated in FIG. 14, only the attribute that has “John Doe” as its attribute value may be displayed as an option.

FIG. 7 illustrates an example of a screen that includes a new search result 702. The new search result 702 is displayed when the condition for the refined search is reselected from the reselection screen illustrated in FIG. 6 and the refined search is performed. In the case illustrated in FIG. 7, “John Doe” is newly added to the search condition as the attribute value of the “last person to print document” 701. According to this search, one document “B.doc” is added. By adding the condition for the refined search, the document that the user is searching for is obtained.

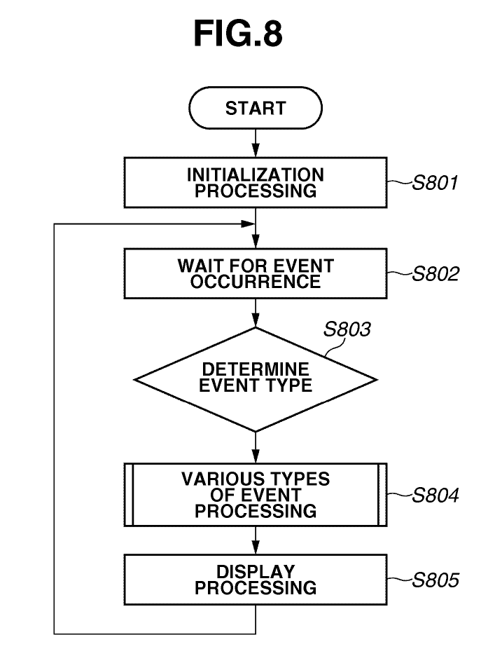

FIG. 8 is a flowchart illustrating a basic operation of the search condition designation apparatus according to the present exemplary embodiment. In step S801, the CPU 101 performs initialization processing of the system. In step S801, various parameters are initialized and the screen is displayed.

In step S802, the CPU 101 waits until an event occurs, for example, the user presses a button in the input device 104.

When the event occurs, in step S803, the CPU 101 determines the event that occurred and sorts out processing to be performed according to a type of the event. In FIG. 8, a plurality of types of processing that correspond to the various types of events are performed in step S804.

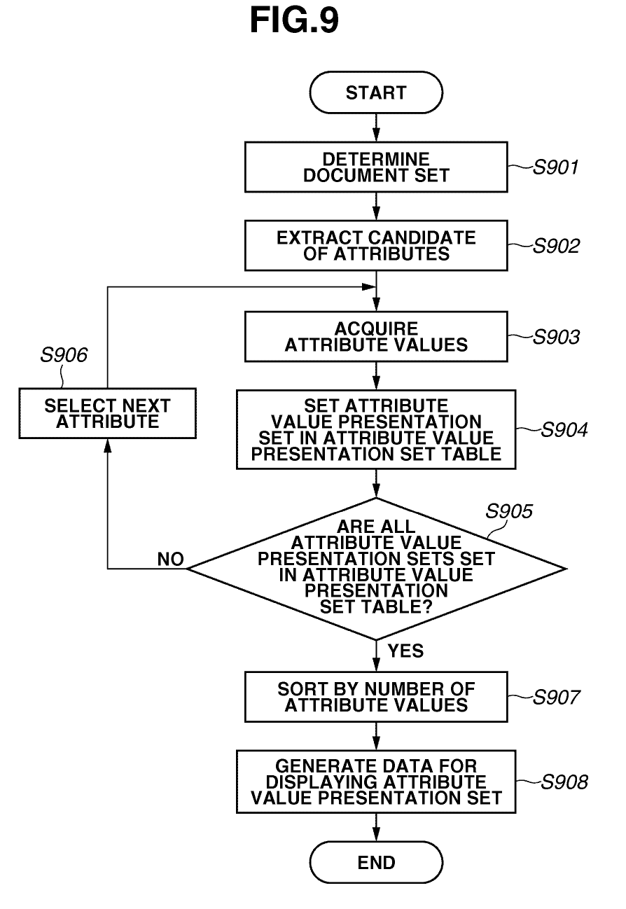

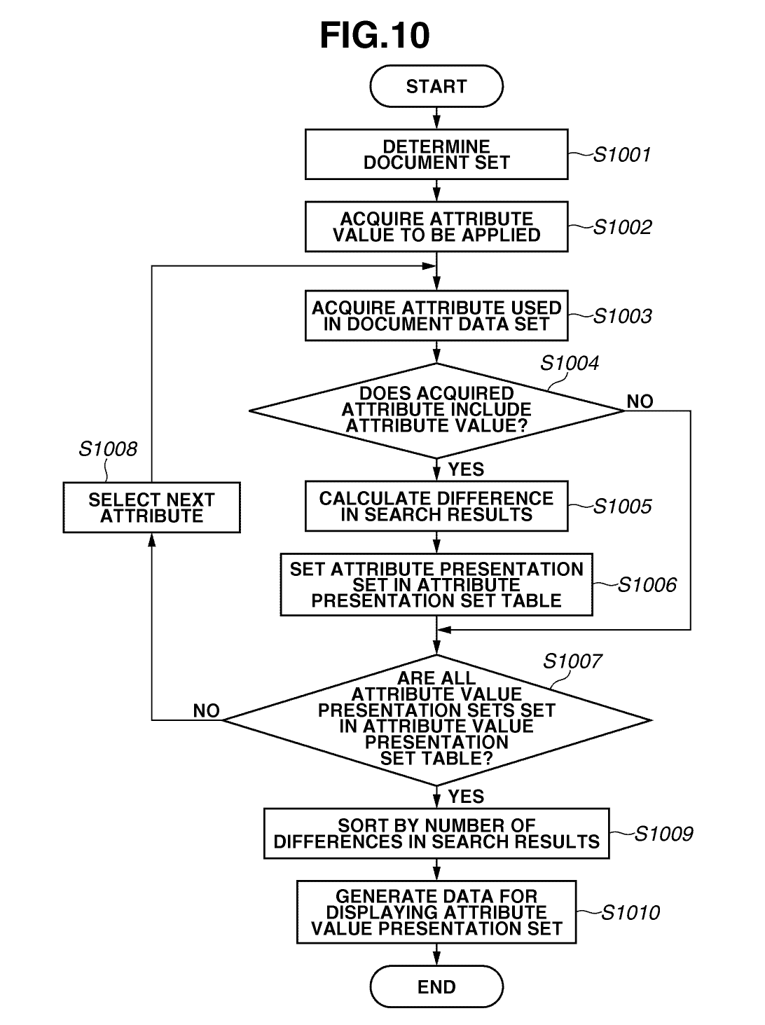

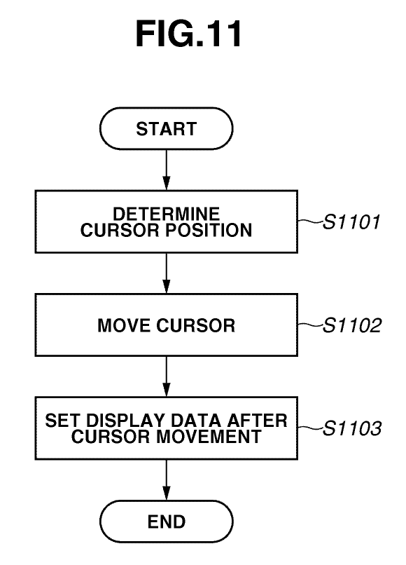

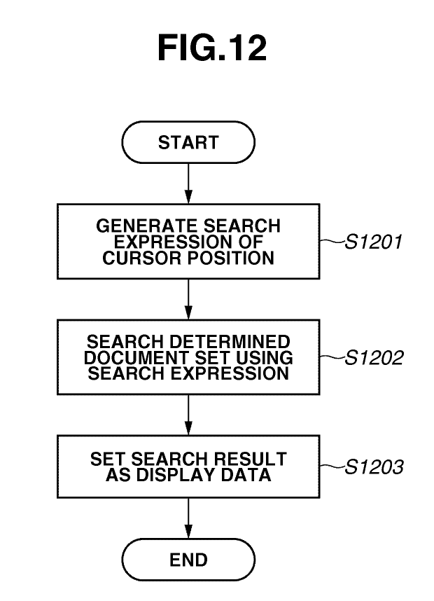

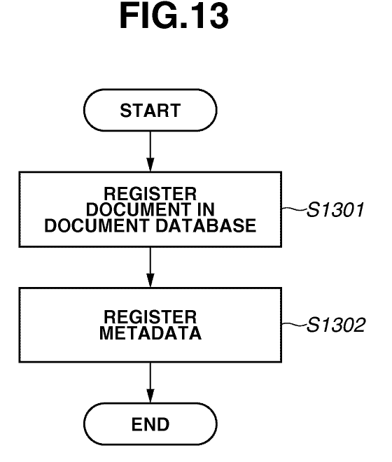

The plurality of types of processing performed in step S804 include attribute value presentation processing illustrated in FIG. 9, attribute presentation processing illustrated in FIG. 10, cursor movement processing illustrated in FIG. 11, search execution processing illustrated in FIG. 12, and document registration processing illustrated in FIG. 13. Although details of other processing are not described, document database management processing and document editing processing can also be included.

In step S805, the CPU 101 displays the screen for notifying a processing result or termination according to an instruction of each of the various types of processing. More specifically, the processing in step S805 includes the processing that is normally performed such as the display of error when an error occurs or the display of data, which is set in advance, on the screen when normal processing is performed.

FIG. 9 is a flowchart illustrating an operation of the attribute value presentation processing which is one of the processing included in step S804 in FIG. 8.

In step S901, the CPU 101 determines a document data set as a processing target. All pieces of the document data in the document database may be the processing target. However, for example, if a search result is displayed once and a refined search is instructed, a set of document data that is narrowed down from a part of the document database is processed as a designated document set.

In step S902, the CPU 101 extracts a candidate of the attributes used in the document data set. If an attribute exists in the document database, but is not used in the designated document set that is a subset of the document database, the attribute will be excluded in advance.

In step S903, the CPU 101 acquires the candidate attribute values. According to the present exemplary embodiment, all the user names included in the user table 202 in FIG. 2 are acquired.

In step S904, the CPU 101 generates and sets an attribute value presentation set in the attribute value presentation set table. In other words, the CPU 101 generates the attribute value presentation set table by registering names of all users included in the user table 202 as attribute values for each attribute, and registering a number of the attribute values.

When the setting is completed, in step S905, the CPU 101 determines whether the attribute value presentation sets of all the attributes are set in the attribute value presentation set table. If an unprocessed attribute exists (NO in step S905), then the process proceeds to step S906. In step S906, the CPU 101 selects the next attribute, and the process returns to step S903.

On the other hand, in step S905, if the CPU 101 determines that the attribute value presentation sets of all the attributes are set in the attribute value presentation set table (YES in step S905), then the process proceeds to step S907. In step S907, the CPU 101 sorts out the attribute value presentation sets generated in the attribute value presentation set table by the number of the attribute values.

In step S908, the CPU 101 sets the attribute value presentation set as the data to be displayed in the sort order. According to this process, the selection area 501 illustrated in FIG. 5 is generated. The process in step S908 is an example of processing by an attribute value presentation unit according to the present invention.

FIG. 10 is a flowchart illustrating an operation of the attribute presentation processing which is one of the processing included in step S804 in FIG. 8.

In step S1001, the CPU 101 determines the document data set as the processing target. All pieces of the document data in the document database may be the processing target. However, for example, if a search result is displayed once and a refined search is instructed, the set of document data that is narrowed down from a part of the document database is processed as the designated document set.

In step S1002, the CPU 101 acquires an attribute value to be applied. The value that is acquired in step S1002 is the attribute value that the user selects from the screen illustrated in FIG. 5. Accepting the attribute value designated by the user is an example of processing by an attribute value designation accepting unit according to the present invention.

In step S1003, the CPU 101 acquires the attribute that is used in the document data set.

In step S1004, the CPU 101 determines whether the acquired attribute includes the above-described attribute value by referring to the attribute value presentation set table. If the attribute does not include the above-described attribute value (NO in step S1004), then the process proceeds to step S1007. On the other hand, if the attribute includes the above-described attribute value, then the process proceeds to step S1005. In step S1005, the CPU 101 executes the search by adding “attribute=attribute value” to the refined search condition through the document data set, and calculates the difference between the refined search results and the current search results. The process in step S1005 is an example of processing by a search result difference calculation unit according to the present invention.

In step S1006, the CPU 101 generates and sets attribute information in the attribute present setting table. When the information is set, the process proceeds to step S1007.

In step S1007, the CPU 101 determines whether processing of all the attributes used in the document data set is completed. If an unprocessed attribute exists (NO in step S1007), then the process proceeds to step S1008. In step S1008, the CPU 101 selects the next attribute, and the process returns to step S1003.

On the other hand, in step S1007, if the CPU 101 determines that the processing of all the attributes is completed (YES in step S1007), then the process proceeds to step S1009. In step S1009, the CPU 101 sorts out the attribute presentation sets generated in the attribute presentation set table by the number of differences in the search results.

In step S1010, the CPU 101 sets the attribute presentation set as the data to be displayed in the sort order. According to this process, the reselection screen illustrated in FIG. 6 is generated. In the reselection screen illustrated in FIG. 6, a list of attributes that excludes the attribute which already includes the attribute value that is designated in the search screen illustrated in FIG. 5 is displayed. Although a list of the attributes that is simply displayed is illustrated as an example in the reselection screen in FIG. 6, as another embodiment, the attributes can be displayed by a pull-down list. The process in step S1010 is an example of processing by an attribute presentation unit according to the present invention.

FIG. 11 is a flowchart illustrating an operation of the cursor movement processing which is one of the processing included in step S804 in FIG. 8.

In step S1101, the CPU 101 obtains a cursor position.

In step S1102, the CPU 101 actually moves the cursor to an obtained position.

In step S1103, the CPU 101 sets display data after the cursor movement.

FIG. 12 is a flowchart illustrating an operation of the search execution processing which is one of the processing included in step S804 in FIG. 8.

In step S1201, the CPU 101 generates a search expression including a set of AND operation of “attribute=attribute value”. Here, “attribute=attribute value” is a combination of the attribute and the attribute value that is determined by the user changing the cursor position in the screen illustrated in FIG. 5 or FIG. 6.

In step S1202, the CPU 101 searches the determined document set using the generated search expression. Step S1202 is an example of processing by a search execution unit according to the present invention.

In step S1203, the CPU 101 sets the search result as the display data. Accordingly, the result display area 502 illustrated in FIG. 5 is generated.

FIG. 13 is a flowchart illustrating an operation of the document registration processing which is one of the processing included in step S804 in FIG. 8.

In step S1301, the CPU 101 registers a main body of the document data in the document database.

In step 1302, the CPU 101 registers metadata included in the document data in the document metadata management table.

According to the above-described exemplary embodiments, once an attribute value is designated as a search condition, a list of attributes corresponding to the attribute value is presented, and an attribute to which the designated attribute value is applied is further designated as the search condition from the presented attribute list. Thus, the time and effort of the user for designating the search condition can be reduced and the desired search target can be obtained more easily.

Further, according to the above-described exemplary embodiments, since a difference between the refined search results when the attribute value designated as the search condition is applied to each attribute and the search results of the current search is presented, the increase or decrease of the number of the search results when the search condition is changed can be obtained before the actual search is performed.

Although the document data that is managed by the search condition designation apparatus is the target document data according to the above-described exemplary embodiments, any type of files can be selected so long as the data of the file can be managed by metadata.

Each unit and step that constitutes the configuration of the above-described exemplary embodiments can be realized by running a program stored in a RAM or a ROM of a computer. The present invention includes such a program and a computer-readable recording medium which stores the program.

Further, the above-described exemplary embodiments can be also realized by, for example, a system, an apparatus, a method, a program, or a recording medium. More specifically, the above-described exemplary embodiments can be applied to an apparatus including a single device.

The above-described exemplary embodiments can also be achieved by directly or remotely supplying a software program that realizes each function of the above-described exemplary embodiments to the system or the apparatus and a computer included in the system reading out and executing the provided program code.

Thus, the program code itself which is installed in the computer to realize the functions and the processing of the present invention on the computer constitutes the present invention. In other words, the computer-executable program configured to realize the functions and the processing of the present invention itself constitutes an exemplary embodiment of the present invention. In such a case, as long as the function of the program is implemented, any form, for example, an object code, a program implemented by an interpreter, or a script data to be supplied to an operating system (OS) may be employed.

Further, the functions of the above-described exemplary embodiments can be realized by a computer which reads and executes the program. An OS or the like running on the computer can perform a part or whole of the actual processing based on an instruction of the program. This case can also realize the functions of the above-described exemplary embodiments.

Further, a program read out from a storage medium can be written in a memory provided in a function expansion board inserted in a computer or a function expansion unit connected to the computer. Based on an instruction of the program, the CPU of the function expansion board or the function expansion unit can execute a part or all of the actual processing. The functions of the above-described exemplary embodiments can be realized in this manner.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application 2008-257277 filed Oct. 2, 2008, which is hereby incorporated by reference herein in its entirety.

What is claimed is:

1. A search condition designation apparatus comprising:
an attribute value presentation unit configured to present a list of an attribute value which is selectable for each attribute;
an attribute value designation accepting unit configured to accept designation of the attribute value from the list of the attribute value which is presented by the attribute value presentation unit;
an attribute presentation unit configured to present a list of an attribute corresponding to the attribute value the designation of which is accepted by the attribute value designation accepting unit;
an attribute designation unit configured to accept designation of the attribute from the list of the attribute which is presented by the attribute presentation unit; and
a search execution unit configured to execute search of data using a search condition based on the attribute value the designation of which is accepted by the attribute value designation accepting unit and the attribute the designation of which is accepted by the attribute designation unit.

2. The search condition designation apparatus according to claim 1, further comprising a number-of-searches difference calculation unit configured to calculate a difference between a current number of searches and a number of searches obtained in a case where each attribute included in the list of attribute is set as the attribute value accepted by the attribute value designation accepting unit, wherein the attribute presentation unit further presents the difference in the number of searches calculated by the number-of-searches difference calculation unit.

3. The search condition designation apparatus according to claim 1, wherein the attribute presentation unit presents a list including only the attribute that includes the attribute value the designation of which is accepted by the attribute value designation accepting unit.

4. The search condition designation apparatus according to claim 1, wherein the attribute presentation unit presents the list of the attribute in which the attribute that includes the attribute value the designation of which is accepted by the attribute value designation accepting unit and the attribute that does not include the attribute value, are distinguished from each other.

5. The search condition designation apparatus according to claim 4, wherein the attribute presentation unit presents a list including the attribute that applies to a type of the attribute value the designation of which is accepted by the attribute value designation accepting unit.

6. The search condition designation apparatus according to claim 1, wherein the attribute presentation unit presents the list of the attribute excluding the attribute in which the attribute value the designation of which is accepted by the attribute value designation accepting unit is already designated.

7. The search condition designation apparatus according to claim 1, wherein the attribute presentation unit presents the list of the attribute corresponding to the attribute value the designation of which is accepted by the attribute value designation accepting unit by a pull-down list.

8. The search condition designation apparatus according to claim 1, wherein the search execution unit executes the search based on a logical conjunction of the search condition and a different search condition.

9. A method for designating a search condition by a search condition designation apparatus, the method comprising:
presenting a list of an attribute value selectable for each attribute;
accepting designation of the attribute value from the presented list of the attribute value;
presenting a list of the attribute corresponding to the attribute value the designation of which is accepted;
accepting designation of the attribute from the presented list of the attribute; and
executing search of data using a search condition based on the attribute value the designation of which is accepted and the attribute the designation of which is accepted.

10. A computer-readable storage medium storing a program for causing a computer to perform operations, the program comprising:
presenting a list of an attribute value selectable for each attribute;
accepting designation of the attribute value from the presented list of the attribute value;
presenting a list of attribute corresponding to the attribute value the designation of which is accepted;
accepting designation of the attribute from the presented list of the attribute; and
executing search of data using a search condition based on the attribute value the designation of which is accepted and the attribute the designation of which is accepted.
